(19) United States
(12) Patent Application Publication
(10) Pub. No.: US 2014/0132934 A1
(43) Pub. Date: May 15, 2014

(54) 6-color multi-channel image engine

(71) Applicants: Max Mayer, Forchheim (DE); Bernhard Rudolf Bausenwein, Hagelstadt (DE)

(72) Inventors: Max Mayer, Forchheim (DE); Bernhard Rudolf Bausenwein, Hagelstadt (DE)

(21) Appl. No.: 13/694,263

(22) Filed: Nov. 14, 2012

(51) Int. Cl. G03B 21/20

(52) U.S. Cl. CPC G03B 21/2013
USPC 353/31; 353/121

(57) ABSTRACT

A 6-color multi-channel image engine comprises a spatial light modulation system (SLMS) configured to output two spatially modulated light beams, a short wavelength beam (SWL) with the three wavelength bands of the first and second blue and of the first green (B1,B2,G1) and a long wavelength beam (LWL) with the three longer wavelength bands of the second green and of the first and second red (G2,R1,R2) is disclosed. The engine further comprises an adder (ADDER). This adder is configured to combine the short wavelength beam (SWL) and the long wavelength beam (LWL) into a 6-color output beam (OUT).

### BACKGROUND OF THE INVENTION

1. Field of the invention

The invention relates to multi-channel projection systems using several spatial light modulators and light combining means to combine the spatially modulated light beams of the several spatial light modulators. More specifically the invention relates to systems based on a six color management for enlarging the usual three color space or for color-coded stereoscopic projection.

2. Description of related art

Color perception in the human visual system is based on three different receptors in the human eye with dominant excitation in the red, green and blue light spectrum. Therefore, color impressions experienced by the human visual system can be evoked by a respective mixture of only three rather narrow spectral wavelength bands in an additive manner. This can be realized e.g. even with three monochromatic laser light sources emitting a red, a green, and a blue wavelength. E.g., excitation of the red receptor with light in the red spectrum and excitation of the green receptor with light in the green spectrum without exciting the blue receptor results in an experienced impression of yellow by the human being. It cannot be discriminated by the human visual system from stimulation with light in the yellow spectral range. Projection systems and other display systems comfortably use this lack of discrimination of the human visual system to synthesize a broad range of color impressions with a respective mix of a red, a green and a blue beam of light.

Multi-channel color projection systems are characterized by several spatial light modulators, which are e.g. used in three-chip systems to spatially modulate a red, a green, and a blue beam of light simultaneously, whereby these three beams are combined by a dichroic light combiner. This can be realized by dichroic cross combiners (e.g. U.S. Pat. No. 7,963,657B2, Amano et al.; US20100033681A1, Maeda; US20060244920A1, Kawaai; U.S. Pat. No. 6,010,221A Maki et al.) the roots of which originate already in 1915 (GB191513042, Harold Workman) or trichroic prism assemblies (TPAs, e.g. U.S. Pat. No. 6,250,763B1, Fielding et al.; U.S. Pat. No. 6,561,652B1, Kwok et al.; U.S. Pat. No. 6,229,581 B1 Yamamoto et al.; US7396132B2, Vandorpe et al.; US20070014114A1, Barazza; US20090103054A1, Ichikawa et al.; US20070229770A1, Miyata et al.) in order to create a spatially modulated color image.

There are also 2-chip systems with less complexity wherein one spatial light modulator modulates a first and a second color in a fast time-sequential alternating mode and a second spatial light modulator constantly modulates a third color (US20050001995A1, Dewald et al.; U.S. Pat. No. 5,905,545A, Poradish et al.).

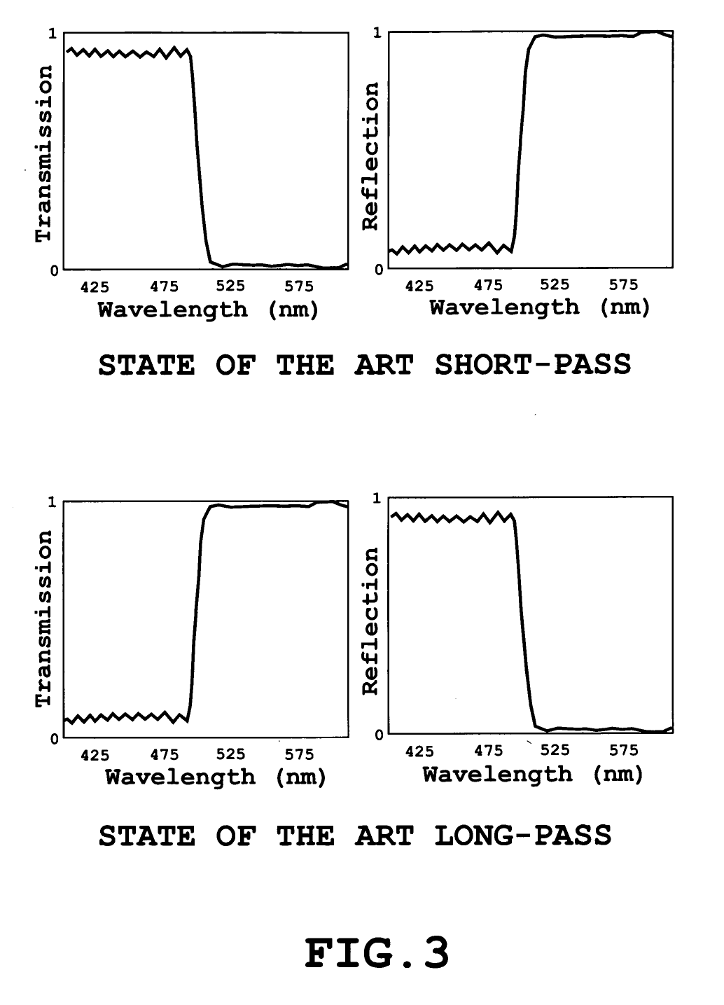

All these color image engines with two or three chips use simple dichroic color splitting layers to combine the separately modulated color components. The characteristics of these dichroic combiners in the state of the art are shown in FIG. 3. In FIG. 3 (upper diagrams) the very simple characteristics of such a dichroic filter is shown in the form of a short-pass. Light with wavelengths below a certain threshold transmit the short-pass (left upper diagram), while light with longer wavelengths is reflected by the short-pass (right upper diagram). The reciprocal characteristics of a so-called long-pass are shown in FIG. 3 (lower diagrams).

Color image engines with only one spatial modulator do not need any color combiner; these single-chip engines (e.g. of the type Micro-Opto-Electro-Mechanical-System [MOEMS], ususally deflectable mirror device [DMD] produced by Texas Instruments) are used wherein the three primary colors are generated in a fast time-sequential manner by light providing multiplex systems (e.g. U.S. Pat. No. 7,360,905B2, Davis et al.; U.S. Pat. No. 6,824,275B2, Penn; US20090161080A1, Liu; U.S. Pat. No. 6,951,394B2, Chang et al.; U.S. Pat. No. 6,185,047B1, Peterson et al.).

While in principle this sequential approach is also applicable to six different colors, time constraints on the imagers and the physiological decomposition of colors (respectively the lack of constitution of these colors) enforce the need to employ dual-engine systems for the expansion of the color space to 6 color components, and also for the use of true parallel stereo projection systems (e.g. using six reflexive liquid crystal on silicon (LCOS) displays as spatial light modulators, U.S. Pat. No. 5,028,121, Baur et al.; US20030020809A1, Gibbon et al.; using two or six MOEMS U.S. Pat. No. 7,403,320B2, Bausenwein et al.; WO2008076113A1, Yoon). In the early times of of stereo projection, these devices consisted of two separate projection systems, one for each eye (e.g. U.S. Pat. No. 6,283,597B1, Jorke). By adding specific filter systems in the output path (e.g. polarizing filters for polarization-coded stereo projection or color filters for color-coded stereo projection) these (often stacked) pairs of monoscopic projectors could be used as true parallel stereo systems.

In a further developmental step two projection systems were coupled by a light combining system, with the result that only a single projection optic was necessary and the adjustment of the two output images could be realized during the production process (e.g. DE19808264C2, Jorke). Furthermore, the light providing system could be reduced to one lamp by additionally using color splitting means upstream the spatial light modulation system (e.g. U.S. Pat. No. 7,001,021 B2, Jorke).

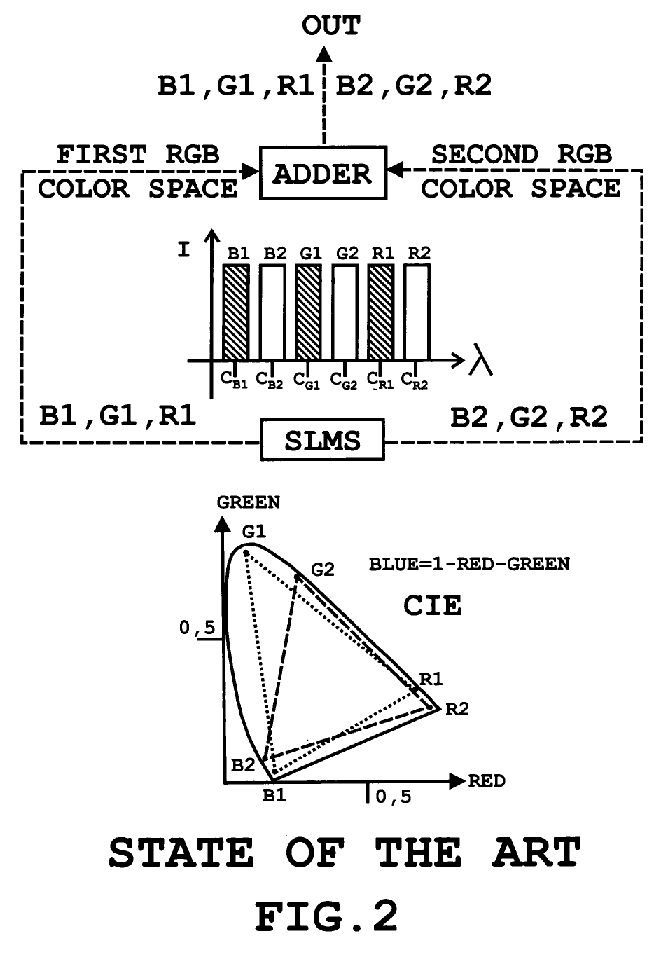

Color-coded stereo projection according to the state of art (FIG. 2) relies on 6 spectral wavelength bands, whereby a first blue, first green and first red band (B1,G1,R1) are used to color code a left eye image with a first modulating system (either with 1 or 3 modulators) and a second blue, second green and second red band (B2,G2,R2) is used to color code a right eye image with a second modulating system (either with 1 or 3 modulators). In these systems, sophisticated efforts have to be made to provide appropriate bands for the left and right systems and, even more so, to combine the left and right image. As both images have a red, a blue, and a green spectral component one method to split, resp. combine the two images is to use multi-band layers (e.g. three-band spectral filters, e.g. U.S. Pat. No. 7,001,021 B2, Jorke; U.S. Pat. No. 7,995,092B2, Lippey).

Such multi-band layers have a complex structure of several layers of interference filters which cause a first red (R1), a first green (G1) and a first blue (B1) spectral band to transmit it, and cause a second red (R2), a second green (G2) and a second blue (B2) spectral band to be reflected by it (FIG. 2).

In time-sequential (multiplex) systems such a multi-band adder is not needed, because the two RGB triplets are presented in an alternating manner. As an example, such a multiplex system with three spatial modulators operating in a time division mode (WO2008061511A1, Jorke), in which a first image built by a first color triplet (R1,G1,B1) and a second image built by a second color triplet (R2,G2,B2) are time-sequentially presented, emerged on the market (by Dolby3D) quickly after patenting. Its multiplex system consists of a rotating color wheel with two three-band spectral filters, one for the right image and one for the left image. In the multi-band filters of the time-sequential engines, only the transmission of the triple band filters is relevant (or, alternatively, only the reflection might be used). The same rational is valid for the eye glasses used for color-coded stereo projection systems: e.g., the glass for the left eye has to transmit the left eye color triplet. Whether it absorbs or reflects the right-eye color triplet is irrelevant for this analyzer.

If, however, multi-band filters are used in parallel engines for combining of the two images, both the reflection and the transmission are important and have to be controlled on the layer, and absorption is critical. Possibly the high requirements for such a multi-band combiner have prevented that these systems emerged on the market up to now, although the idea has been patented for more than 15 years (e.g. DE19808264C2, Jorke).

Therefore, the way to go was to omit these multi-band combiners. One way to achieve this is to differently prepolarize the images for the left and the right eyes (e.g. U.S. Pat. No. 8,029,139B2, Ellinger et al.; US20070146880A1, Bleha et al.; U.S. Pat. No. 7,686,455B2, Yoshimura et al.) and use a simple polarizing beam combiner. This approach was already known from polarization-coded stereo systems (U.S. Pat. No. 5,028,121, Baur et al.) where a first three-chip image engine is used to polarization-code a left eye image with a first red, a first green, and a first blue spectral-band in a first polarization and a second three-chip image engine is used to polarization-code a right eye image with said same first red, first green and first blue spectral-band in a second polarization, and where the two images finally are superposed by a simple polarization beam combiner known in the state of the art since 1943 (U.S. Pat. No. 2,403,731, MacNeille).

However, polarization also has its disadvantages. First, a second type of coding has to be overlayed on an already available color coding, associated with the loss of light caused by either of the codings. Moreover, color combination and polarization interact. Dichroic combiners are sensitive to not only the color of the light beam but also to its polarization (see e.g. U.S. Pat. No. 6,561,652B1, Kwok et al.). Generally speaking, p-polarized light more easily transmits a dichroic layer and s-polarized light more likely reflects at a dichroic layer. Therefore, often so-called SPS color cross combiners are used to combine a red, green and blue spatially modulated light beam. A green light beam, which transmits both the red-reflecting layer and the blue-reflecting layer in a SPS color cube should be P-polarized, while the red and blue light-beams should be Solarized. If in a 6-color system two color cross combiners have to be used, additional color specific polarization-conversion in both subsystems downstream the light combining system have to be used. This means e.g. that one SPS RGB beam has to be converted to a SSS RGB beam, e.g. by passing a color specific polarization conversion system that rotates only the green P-polarized light into Solarized light without changing the red and blue Solarized light components (U.S. Pat. No. 7,963,657B2, Amano et al.) and a second SPS RGB beam has to be converted to an PPP RGB beam, before the two beams could be combined by a polarization splitter.

Another disadvantage of polarization as a stringent requirement is related to the type of spatial light modulators used; with all liquid crystal modulators being based on polarization, these need input beams of a defined prepolarization, which increases the complexity of a polarization- and color-coded image engine layout.

### BRIEF SUMMARY OF THE INVENTION

This application unravels a third and surprisingly simple way to cope with the circumstances of light combining in 6-color multi-channel projection systems, without the requirement of a multi-band combiner, and without the requirement of different prepolarization for the left and the right image.

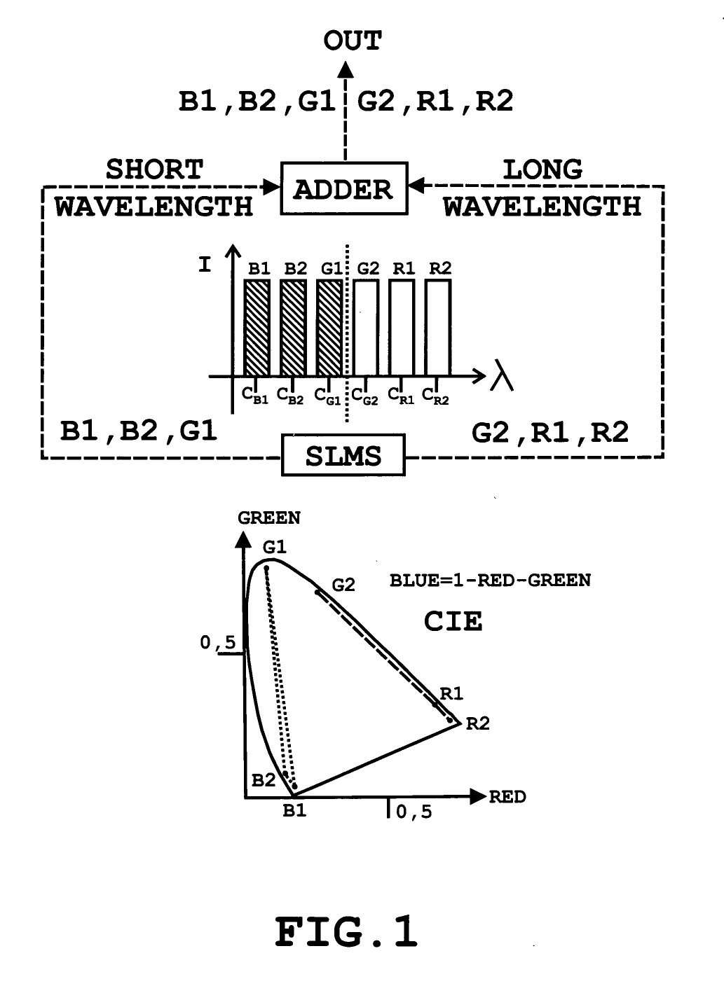

Historically, and in the state of the art, the primary color set used for the presentation of an image was coupled to one modulator or to one output of a spatial light modulating system in multi-channel systems. In a first inventive step we released these “evolutionary” constraints. This resulted in an increase of freedom to arrange the 6 color bands in a new way. In this disclosure, we arrange the color bands in a wavelength-sorted way. A first output beam of the spatial light modulation system (SLMS) of the disclosed engine (FIG. 1) does not output a complete trichromatic RGB image like the engines described in the state of the art, but outputs only light with the 3 wavelength bands with the shorter wavelengths (the first and second blue wavelength bands (B1, B2) and the first green (G1), see the short wavelength beam (SWL) in FIG. 1. A second beam (LWL) collects the three wavelength bands with longer wavelength of the second green (G2) and the two reds (R1, R2).

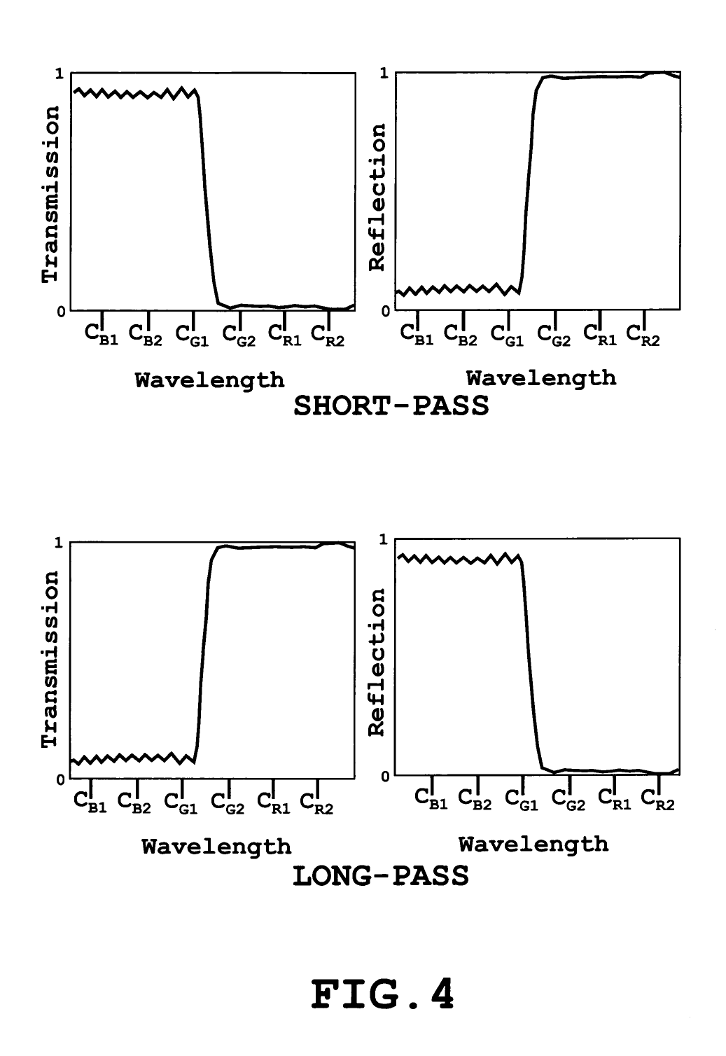

In contrast to the state of the art, a single threshold wavelength between the first and second green separates the two modulated beams (SWL, LWL). As a consequence, a very simple light combining scheme can be achieved, in which e.g. a simple dichroic layer with just one threshold wavelength between the two greens can be used as a combiner. Comparing the FIGS. 1 (our disclosure) and 2 (state of the art), it becomes obvious that in our disclosure the first output of the spatial light modulation system (SWL) is not used to modulate the first blue (B1), the first green (G1) and the first red (R1) light beams (e.g. for the left eye), but the short wavelength bands (B1,B2,G1). Similarly, the second output of the light modulation system (LWL) is not used to modulate the second blue (B2), the second green (G2) and the second red (R2) light beams (e.g. for the right eye), but is used to modulate the three long wavelength bands of the second green, the first and the second red (G2,R1,R2). Multi-band adders are not needed, any simple adder, e.g. a simple dichroic layer with a single threshold value between the greens may be used for the combining (ADDER). FIG. 4 shows the transmission and reflection characteristics of such a short-pass and a long-pass slightly adjusted from a state of the art version of FIG. 3 to match with the invention. Of course, a polarizing beam splitter might also be used as adder, e.g. if the beams were prepolarized, which might be caused by other reasons. Polarization, while in the scope of the disclosure, is however in no way a prerequisite for the disclosed engine.

Of course, pixel-exact alignment of the two outputs is required to superpose the wavelengths with the adder. Only after the superposition by the adder trichromatic RGB images are constituted in the 6-color output (OUT); neither the short wavelength beam (SWL) nor the long wavelength beam (LWL) of the spatial light modulating system (SLMS) carry a full RGB color image (see CIE diagram of FIG. 1). The requirement of pixel-exact alignment is however not a new requirement uncovered with this disclosure, but is a requirement which is met in the state of the art in all three-chip system, which is standard in liquid crystal displays and in 3-chip DMD projection systems).

### LIST OF DESIGNATORS USED IN DRAWINGS

SLMS spatial light modulating system
ADDER adder
X-ADDER cross of two adders
B1,B2 first and second blue, different wavelength bands
G1,G2 first and second green, different wavelength bands
R1,R2 first and second red, different wavelength bands
C_{WB} central wavelength of the wavelength band WB
I intensity

SWL short wavelength beam of the SLMS

LWL long wavelength beam of the SLMS

OUT 6-color output

λ wavelength (lambda)

M1,M2,M3,M4,M5,M6 spatial light modulators

COMB light combiner

SPLIT light splitter

B1 B2G1, G2R1 R2 short-, long-wavelength light source

MUX time-multiplex system for time-sequential color sequencing

B1,B2,G1 light sequence (of single wavelength bands)
G2,R1,R2 light sequence (of single wavelength bands)
B1 G2,B2R1,G1 R2 light sequence (of two wavelength bands)
B1R1,B2R2,G1G2 light sequence (of two wavelength bands)
X_{SWL} color-combiner cross for the shorter wavelengths
X_{LWL} color-combiner cross for the longer wavelengths

TIR1, TIR2 total internal reflection means

### BRIEF DESCRIPTION OF THE SEVERERAL VIEWS OF THE DRAWINGS

FIG. 1 shows a scheme of the disclosed 6-color multi-channel image engine.

FIG. 2 shows a 6-color multi-channel image engine according to the state of the art.

FIG. 3 shows short-pass and long-pass characteristics according to the state of the art.

FIG. 4 shows short-pass and long-pass characteristics according to the invention.

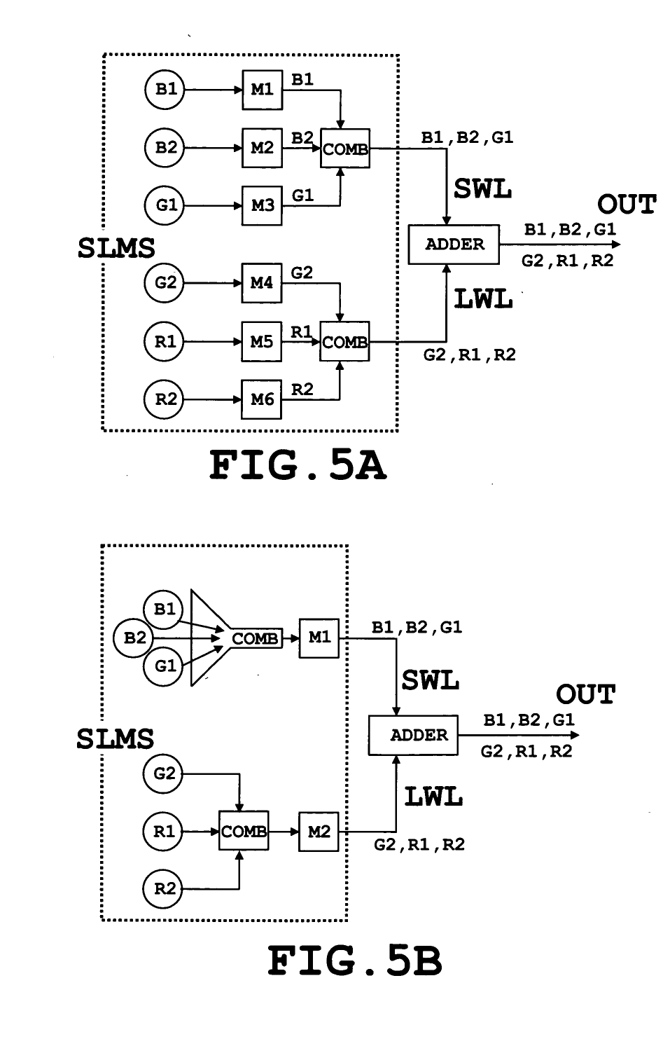

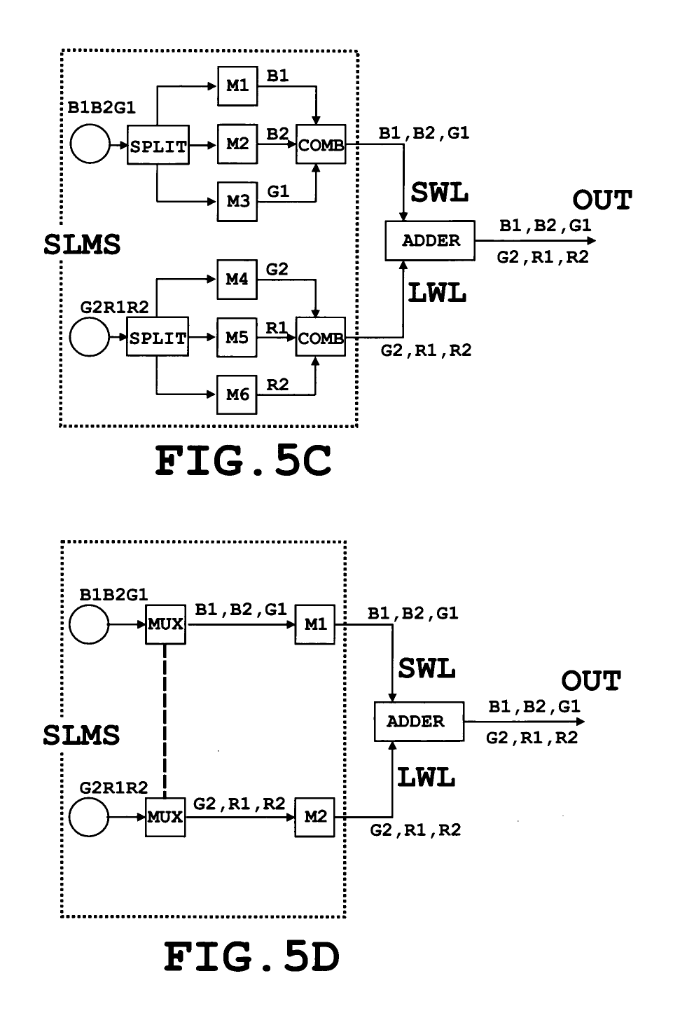

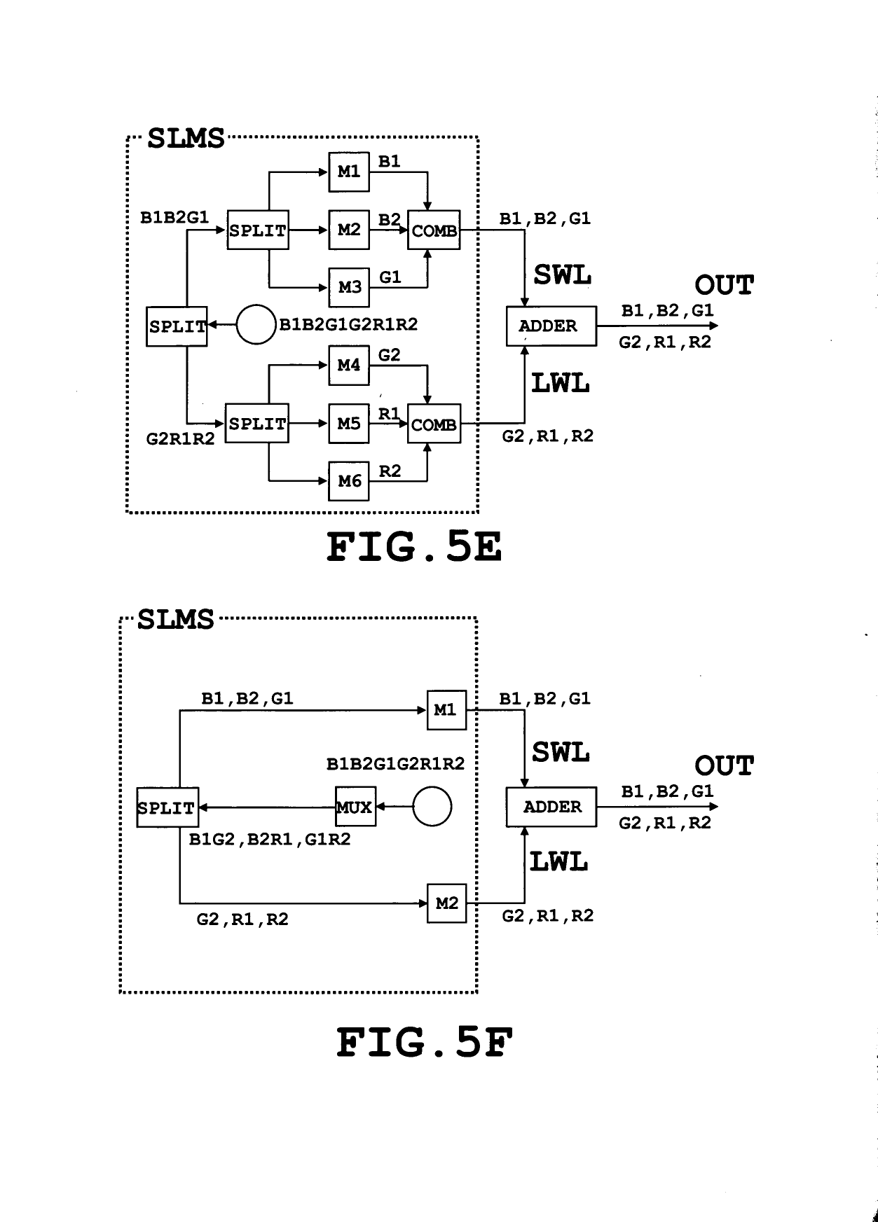

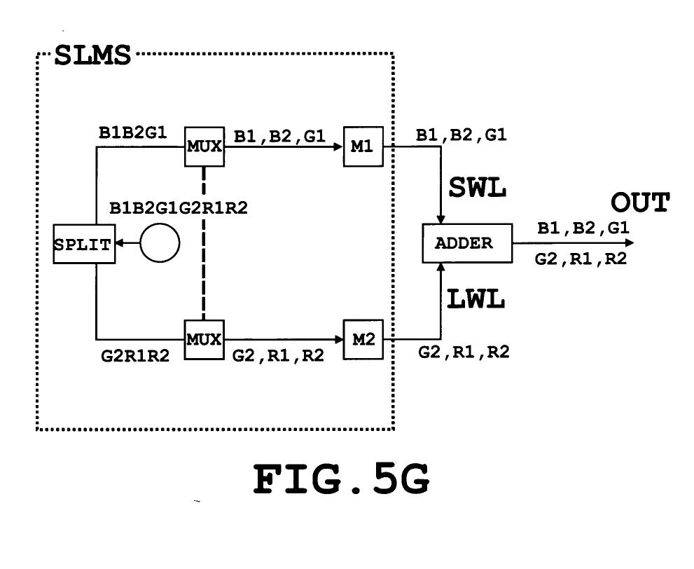

FIG. 5A shows a first implementation of the scheme shown in FIG. 1.

FIG. 5B shows a second implementation of the scheme shown in FIG. 1.

FIG. 5C shows a third implementation of the scheme shown in FIG. 1.

FIG. 5D shows a fourth implementation of the scheme shown in FIG. 1.

FIG. 5E shows a fifth implementation of the scheme shown in FIG. 1.

FIG. 5F shows a sixth implementation of the scheme shown in FIG. 1.

FIG. 5G shows a seventh implementation of the scheme shown in FIG. 1.

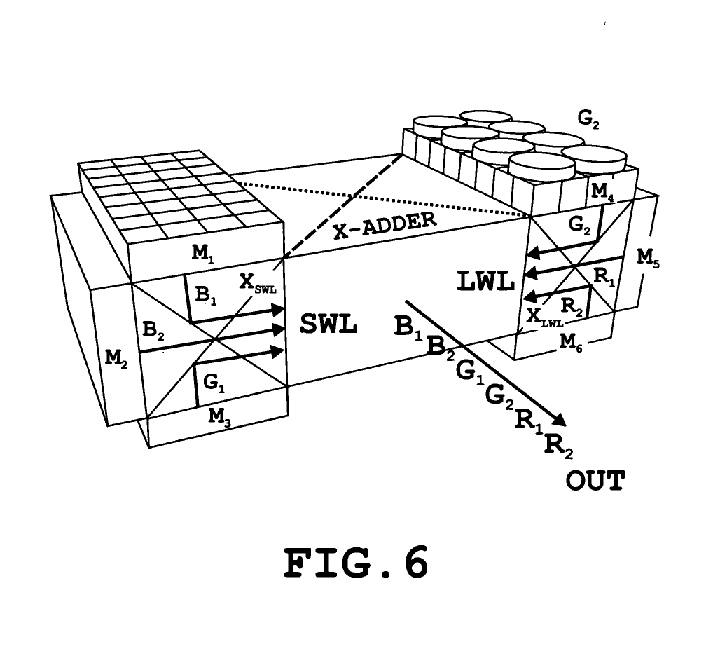

FIG. 6 shows a perspective view of a realization of the first implementation shown in FIG. 5A.

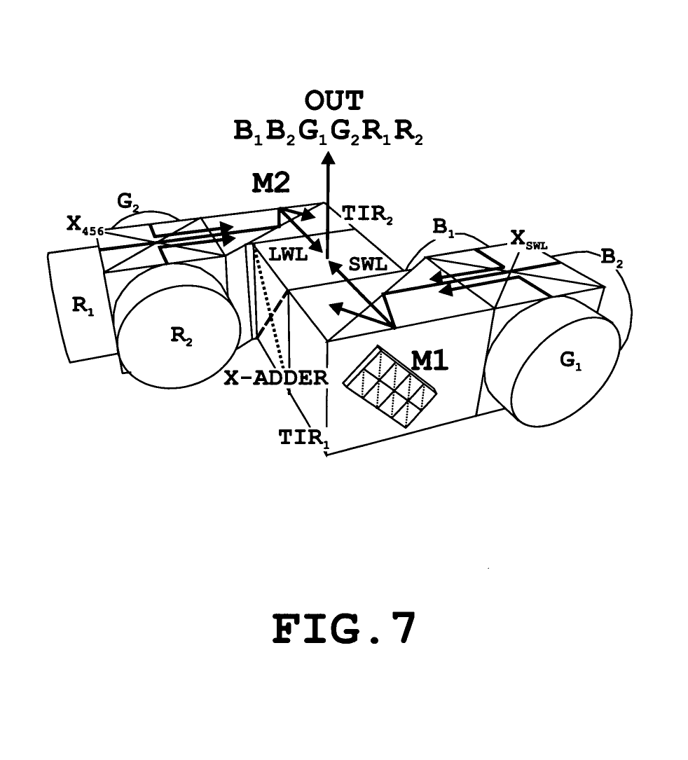

FIG. 7 shows a perspective view of a realization of the second implementation shown in FIG. 5B.

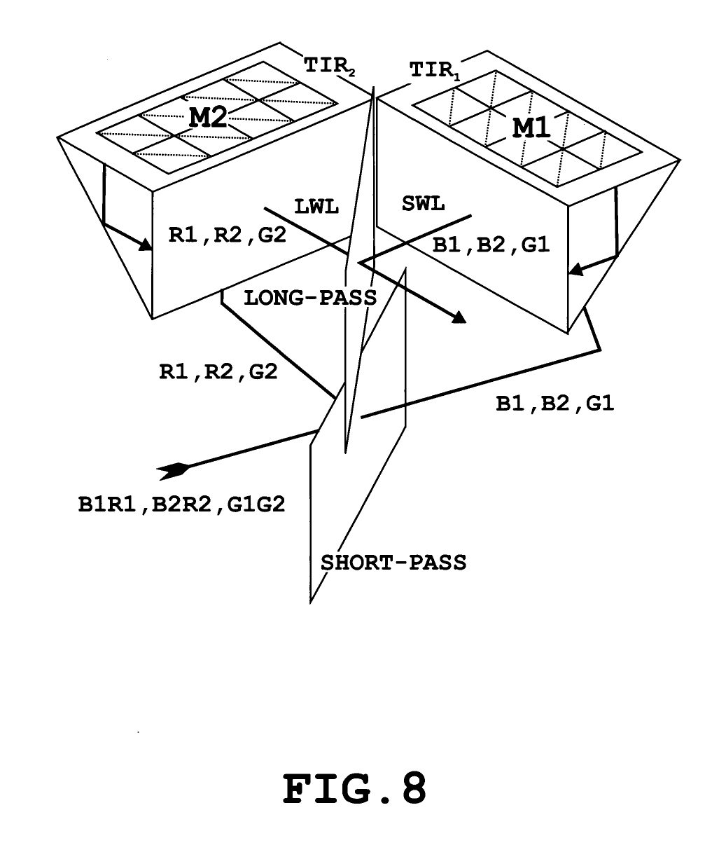

FIG. 8 shows a perspective view of a realization of the sixth implementation shown in FIG. 5F.

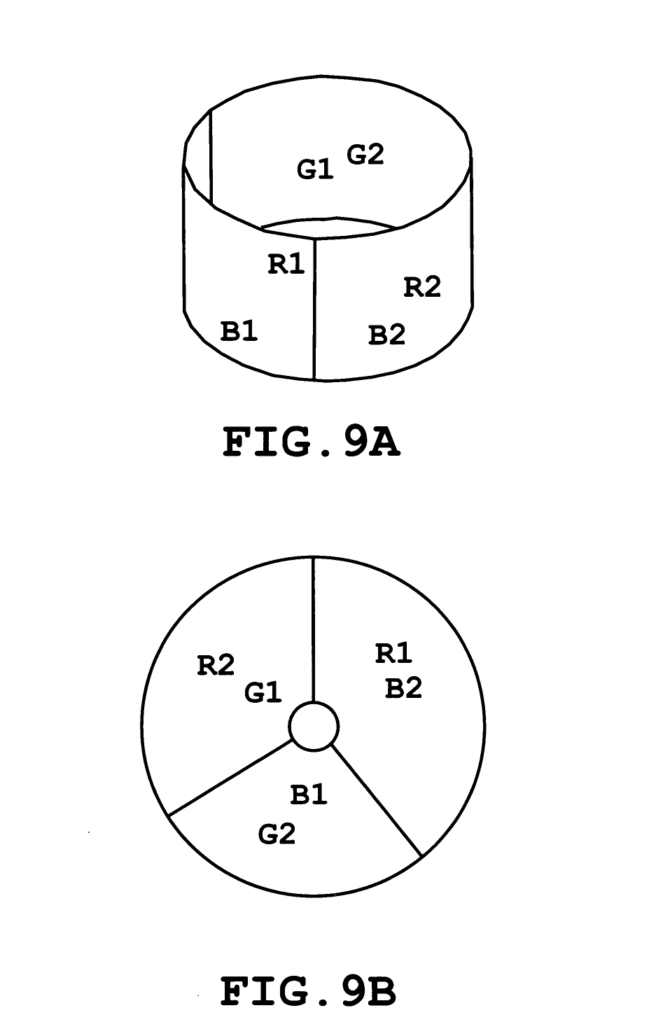

FIG. 9A schematically shows a perspective view of a first rotatory actuator usable in the sixth implementation.

FIG. 9B schematically shows a side view of a second rotatory actuator usable in the sixth implementation.

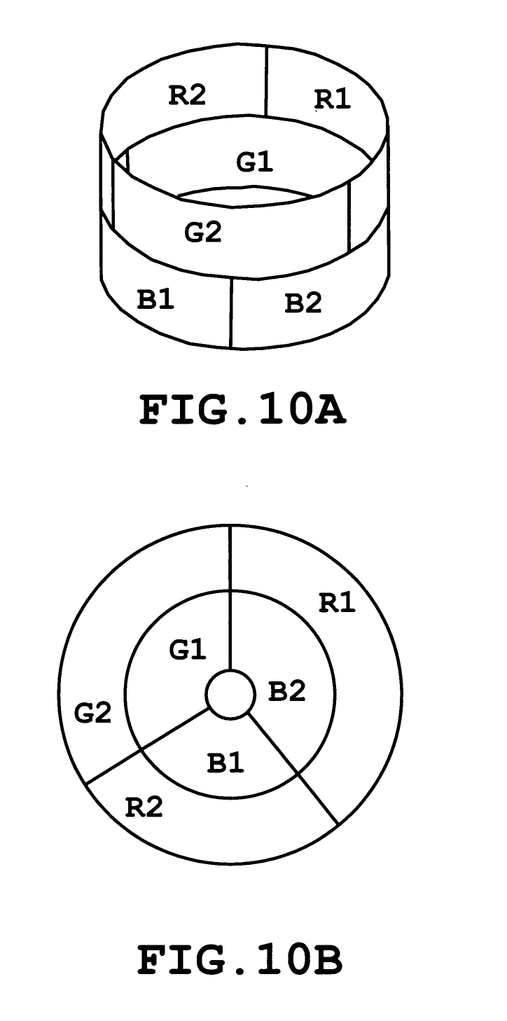

FIG. 10A schematically shows a perspective view of a third rotatory actuator usable in the fourth and seventh implementation.

FIG. 10B schematically shows a side view of a fourth rotatory actuator usable in the fourth and seventh implementation.

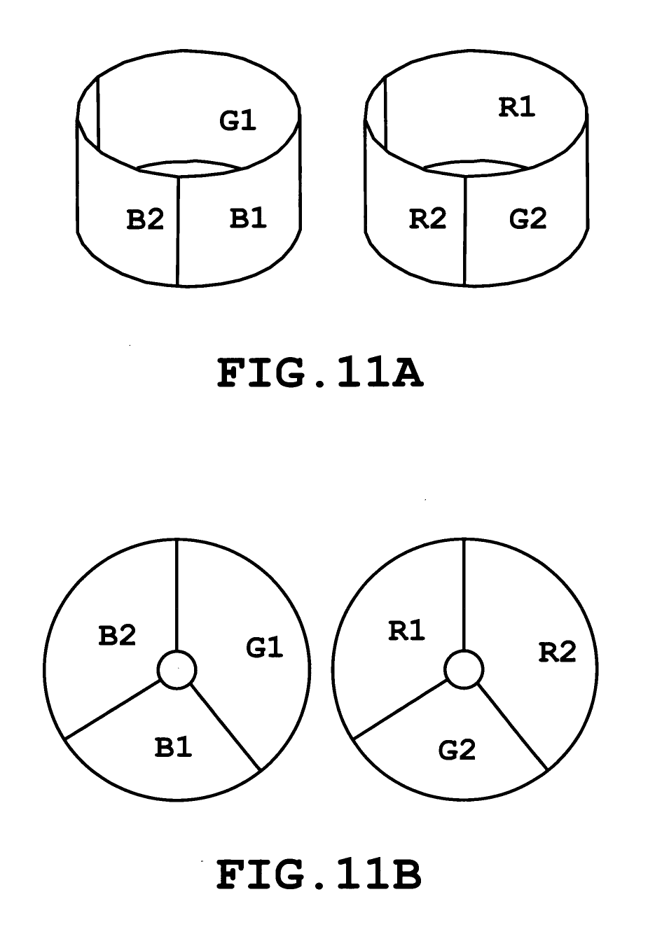

FIG. 11A schematically shows a perspective view of two rotatory actuators usable in the fourth and seventh implementation.

FIG. 11B schematically shows a side view of two rotatory actuators usable in the fourth and seventh implementation.

### DETAILED DESCRIPTION OF THE INVENTION

The invention will be described in the following on the basis of the scheme of the disclosed 6-color multi-channel image engine shown in FIG. 1. This scheme is found in all implementations (FIGS. 5-8). FIG. 3 shows short-pass and long-pass characteristics of two adders according to the state of the art and FIG. 4 shows adjusted short-pass and long-pass characteristics of two adders between the greens (ADDER) which could be used as adders in many implementations. FIGS. 5A-G show some of the various implementations of the disclosure. FIGS. 6-8 show one six-channel and two different two-channel systems according to the invention in a perspective view.

FIG. 1 shows the scheme of the disclosed 6-color multi-channel image engine. A spatial light modulation system (SLMS) is configured to output (OUT) six spatially modulated light beams with 6 different wavelength bands, a first and a second blue (B1,B2) a first and a second green (G1,G2), and a first and a second red (R1,R2). These bands may be characterized by their six central wavelengths (C) which are related such that C_{B1}<C_{B2}<C_{G1}<C_{G2}<C_{G2}<C_{R1}<C_{R2} (see central inset of FIG. 1). The absolute wavelength range of the bands is chosen such that the light beams with the first or second blue wavelength bands (B1,B2) can excite the blue, with the first or second green wavelength bands (G1,G2) can excite the green, and with the first or second red wavelength bands (R1,R2) can excite the red receptors of the human eye. The spatial light modulating system has two modulated output beams. The first spatially modulated beam is a short wavelength beam (SWL) with the three wavelength bands of the first and second blue and of the first green (B1,B2,G1). The second spatially modulated light beam is a long wavelength beam (LWL) with the three longer wavelength bands of the second green and of the first and second red (G2,R1,R2). The central inset shows the wavelength-ordered attribution of wavelength bands to the output; hatched bands are attributed to the left output). Note that the spectral characteristics of the two beams are separated by a single wavelength between the greens (dotted line in the inset). The engine further comprises an adder (ADDER). This adder is arranged to combine spatially modulated light of the short wavelength beam (SWL) and of the long wavelength beam (LWL) into a common output beam (OUT). At the bottom of FIG. 1, a CIE 1931 color space is shown. It is obvious that neither the short wavelength beam (SWL, chromatic color space encircled by a dotted line) nor the long wavelength beam (LWL, encircled by a dashed line) represent a trichromatic RGB image. In obvious contrast to solutions of the state of the art, these spaces appear to be minimized, as a consequence of the wavelength sorting.

A resulting difference to the state of the art is the release of restriction of the characteristics of the adder (ADDER). While 6-color multi-channel image engines of the prior art are based on sophisticated multi-band adders (FIG. 2) or on a second, additional coding of the trichromatic image sets by polarization, the implementations of this disclosure can in principle use very simple adders, e.g. a simple dichroic layer of a color splitter with a single threshold value.

FIG. 2 shows as a comparison a system according to prior art. The drawing shows the similarities and the differences to the disclosed engine shown in FIG. 1. The central difference is the distribution of wavelength bands to the two modulation outputs of the spatial modulating system. In prior art, the allocation of the six spatially modulated light beams is such that wavelength bands constituting a first RGB color space (B1,G1,R1) are mapped to the first output (FIRST RGB COLOR SPACE) and wavelength bands constituting a second RGB color space (B2,G2,R2) are mapped to the second output (SECOND RGB COLOR SPACE). This can be seen in the interleaved distribution of wavelength bands to the outputs (hatched bands go to the left ouput, central inset of FIG. 2) and in the CIE diagram at the bottom of the figure, which shows the two color spaces covered by the first (dotted line) and the second (dashed line) outputs of the spatial light modulating sytem (SLMS). As a consequence, the adding system has to provide complex spectral characteristics of transmission and reflection for the interleaved wavelength bands.

As an obvious contrast to the requirements of the multi-band filters used in the state of the art, we deliberately show the primitive characteristics of a simple dichroic layer with a single threshold value (FIGS. 3,4), which can be used in the engine of our disclosure. FIG. 3 shows the very simple characteristics of a dichroitic layer, in a short-pass and in a long-pass variant. It of course is state of the art. These layers, with an adapted threshold wavelength (FIG. 4), would fulfill all requirements as adder in our disclosure. A single threshold wavelength, which in our disclosure should be a wavelength between the wavelength band of G1 and G2 (see the dotted line in the inset of FIG. 1) characterizes the threshold wavelength of short-pass and long-pass. Light with wavelengths below this threshold (here exemplarily shown at appr. 535 nm) transmits the short-pass with a high efficiency, while light with a longer wavelength than the threshold wavelength does not transmit it (top left diagram of FIG. 4). This light with wavelengths above the threshold is effectively reflected (top right diagram of FIG. 4). In the long-pass, light with wavelengths above the threshold wavelength transmits the layer (bottom left), while light with wavelengths below the threshold is reflected by the layer (bottom right).

Obviously, other adders can be used as combiners For the short and the long wavelengths. For those skilled in the art and science, other variants and forms of adders can easily be deduced, which do not leave the scope of our disclosure.

FIG. 5A shows a first implementation of the scheme shown in FIG. 1. Each of six spatial light modulators (M1-6) are fed by one of six light sources. The six light sources provide six light beams with appropriate spectral characteristics (B1,B2,G1,G2,R1,R2). In this example of a spatial light modulating system (SLMS), each of the 6 wavelength bands is modulated by a spatial modulator. Both the three modulated beams with the three short wavelength bands (B1,B2,G1) and the three modulated beams with the long wavelength bands (G2,R1,R2) are combined by a light combiner (COMB) and form a short wavelength beam (SWL) and a long wavelength beam (LWL). These outputs are combined by an adder (ADDER) into a 6-color (B1,B2,G1,G2,R1,R2) output (OUT). An exemplary realization of this implementation is shown in FIG. 6.

FIG. 5B shows a second implementation of the scheme shown in FIG. 1. The drawing can be read analogous to FIG. 5A. The difference is related to the number of modulation channels of the spatial light modulation systems (SLMS), which is in FIG. 5B reduced to two. Again six light sources, which here e.g. can be switched on and off independently, are used to feed two spatial light modulators (M1, M2). Light of the three light sources providing the short wavelengths (B1,B2,G1) which are used to feed the upper spatial light modulator (M1) is exemplarily shown to be combined by a light funnel as an example of a light integrator (upper COMB). Here, depending on the ON- and OFF-state of the six light sources of the spatial light modulation system, the first spatial light modulator (M1) time-sequentially outputs spatially modulated light with the three short wavelength bands (B1,B2,G1) and the second spatial light modulator (M2) time-sequentially outputs spatially modulated light with the three long wavelength bands (G2,R1,R2). The short wavelength output (SWL) and the long wavelength output (LWL) are combined by an adder (ADDER) into a 6-color (B1,B2,G1,G2,R1,R2) output (OUT). An exemplary realization of this implementation is shown in FIG. 7.

FIG. 5C shows a third implementation of the scheme shown in FIG. 1. The drawing can be read analogous to FIG. 5A. The only difference is related to the number of light sources, which is—in comparison to FIG. 5A, reduced to two. One light source provides the short wavelength bands (B1B2G1) and one provides the long wavelength bands (G2R1R2). As in FIG. 5A, six modulating channels are used. Two color splitters (SPLIT) distribute light with the three short wavelength; bands to the first three spatial light modulators (M1, M2, M3) and light with the three long wavelength bands to the second three spatial light modulators (M4, M5, M6). Both the modulated beams with the three short wavelength bands (B1,B2,G1) and the modulated beams with the long wavelength bands (G2,R1,R2) are combined by a light combiner (COMB) and form a short wavelength beam (SWL) and a long wavelength beam (LWL). These outputs are combined by an adder (ADDER) into a 6-color (B1,B2,G1,G2,R1,R2) output (OUT).

FIG. 5D shows a fourth implementation of the scheme shown in FIG. 1. The drawing can be read analogous to FIG. 5A. The difference in the spatial light modulating channel (SLMS) is now both the number of light sources and the number of modulators, both of which are reduced from 6 to two. Here, two light sources, one for the short wavelengths (B1B2G1) and one for the long wavelength (G2R1R2) are used in combination with two time-multiplex systems (MUX). The time multiplex systems (MUX) could be realized by a rotatory actuator like a color wheel or a color drum, an electronical color sequencer or any other device suited to provide a repetitive sequence of light with a different composition of wavelength bands. In the example, the upper MUX is configured to feed the first spatial light modulator (M1) with an exemplary sequence of light with the short wavelength bands (B1,B2,G1), while the lower MUX is configured to feed the second spatial light modulator (M2) with an exemplary sequence of light with the short wavelength bands (G2,R1,R2). The dashed line between the two time-multiplex systems indicates that the multiplexers could either be realized as independent multiplexers or could be realized as synchronized multiplexers or could even be realized as a common multiplexing actuator (compare the rotatory actuators shown in FIGS. 10,11). Independent multiplexing systems are shown in the form of color drums (FIG. 11A) or color wheels (FIG. 11B), while a composite sequencer is shown in the composite drums or wheels disclosed in FIG. 10. The modulated beam with the three short wavelength bands (B1,B2,G1) is the short wavelength output (SWL) of the SLMS and the modulated beam with the long wavelength bands (G2,R1,R2) is the long wavelength beam (LWL) of the SLMS. These outputs are combined by an adder (ADDER) into a 6-color (B1,B2,G1,G2,R1,R2) output (OUT).

FIG. 5E shows a fifth implementation of the scheme shown in FIG. 1. This implementation is very similar to that shown in FIG. 5C. Here only one light source is used, which is configured to output light of all six spectral ranges (B1B2G1G2R1R2). This light is split by a first splitter into a short wavelength range (B1B2G1) and a long wavelength range (G2R1R2). These triple band containing ranges are again split by two further splitters into beams which Feed just one of the six wavelength bands to each of the six modulators. Both the three modulated beams with the three short wavelength bands (B1,B2,G1) and the three modulated beams with the long wavelength bands (G2,R1,R2) are combined by a light combiner (COMB) and form a short wavelength beam (SWL) and a long wavelength beam (LWL). These outputs are combined by an adder (ADDER) into a 6-color (B1,B2,G1,G2,R1,R2) output (OUT).

FIG. 5F shows a sixth implementation of the scheme shown in FIG. 1. The drawing can be read analogous to and is similar to FIG. 5D except that only one light source (B1B2G1G2R1R2) and only one time-multiplex system (MUX) with one color splitter (SPLIT) are used. The time-multiplex system (MUX) of FIG. 5F is configured to output the six wavelength bands in groups of two bands, whereby both one short wavelength band (B1, B2 or G1) and one long wavelength band (G2, R1 or R2) are outputted at the same time. In the example, the multiplexer time-sequentially provides the first blue and the second green (B1G2) in a first time period, the second blue and the first red (B2R1) in a second time period, and the first green and he second red (G1R2) in a third time period. This could be realized e.g. by a special device like a color wheel uncovered with this disclosure (compare the rotatory actuators of FIGS. 9A,9B) or by electronically switchable color-selection. The two bands leaving the color sequencer are split by a simple color splitter (SPLIT) which has its split wavelength between the greens (G1, G2). The modulated beam with the three short wavelength bands (B1,B2,G1) is the short wavelength output (SWL) of the SLMS and the modulated beam with the long wavelength bands (G2,R1,R2) is the long wavelength output (LWL) of the SLMS. These outputs are combined by an adder (ADDER) into a 6-color (B1,B2,G1,G2,R1,R2) output (OUT). An example realization is shown in FIG. 8.

FIG. 5G shows a seventh implementation of the scheme shown in FIG. 1. The drawing can be read analogous to FIG. 5D or FIG. 5F. The light of a single light source for all 6 spectral bands is split into light of the shorter wavelength range (B1B2G1) and light of a longer wavelength range (G2R1R2) by a splitter (SPLIT). Like in the implementation shown in FIG. 5D, two time-multiplex systems (MUX) are configured to feed light with the three short wavelength bands (exemplarily a repetitive sequence of B1,B2,G1 is shown) to the first spatial light modulator (M1) and light with the three long wavelengths (exemplarily a repetitive sequence of G2,R1,R2 is shown) to the second spatial light modulator (M2). The dashed line between the two time-multiplex systems indicates that the multiplexers could be realized as independent multiplexers or could be realized as synchronized multiplexers or could even be realized as a common multiplexing actuator (compare the rotatory actuators shown in FIGS. 10A,B). The modulated beam with the three short wavelength bands (B1,B2,G1) is the short wavelength output (SWL) of the SLMS and the modulated beam with the long wavelength bands (G2,R1,R2) is the long wavelength output (LWL) of the SLMS. These outputs are combined by an adder (ADDER) into a 6-color (B1,B2,G1,G2,R1,R2) output (OUT).

FIG. 6 shows a perspective view of a realization of the first implementation shown in FIG. 5A. Two color combiners (X_{SWL}, X_{LWL}) are used to combine the spatially modulated light with wavelengths in the short wavelength bands (B1,B2,G1 with X_{SWL}) and with the long wavelength bands (G2,R1,R2 with X_{LWL}). Except for their special wavelength characteristics, these color combiners (X_{SWL}, X_{LWL}) resemble conventional RGB cubes known in the state of the art. The six spatial light modulators (M1-6) are fed by six light sources (only the light source for the second green (G2) is indicated). In the example, the light source for the second green (G2) is realized as an array of light emitting diodes. The adder is shown as a cross (X-Adder, which might be realized by a cross of a short-pass and a long-pass with a threshold wavelength between the two greens (G1, G2)). It is used to combine the light of the short and the long wavelength outputs (SWL, LWL) of the spatial light modulating system (SLMS) into a common output (OUT). The six spatial light modulators are here exemplarily realized as transmissive liquid crystal displays (LCD).

FIG. 7 shows a perspective view of a realization of the second implementation shown in FIG. 5B. Six switchable light sources (B1, B2, G1, G2, R1, R2) alternatively feed light into a short wavelength combiner (X_{SWL}) and a long wavelength combiner (X_{LWL}). These combiners guide the light via two total internal reflection prisms (TIR₁, TIR₂) onto the two modulators (M1, M2) such that the first spatial light modulator (M1) time-sequentially outputs light with wavelengths in the short wavelength bands (B1,B2,G1) via the reflection prism (TIR₁) into the short wavelength output (SWL) and such that the second spatial light modulator (M2) time-sequentially outputs light with wavelengths in the long wavelength bands (G2,R1,R2) via the reflection prism (TIR₂) into the long wavelength output (LWL). Like in FIG. 6, the adder of the short and the long wavelength outputs is realized as a cross (X-ADDER). It combines the light of the short and the long wavelength outputs (SWL, LWL) of the spatial light modulating system (SLMS) into a common 6-color output (OUT, B1,B2,G1,G2,R1,R2). The spatial light modulators are here realized as Micro-Opto-Electro-Mechanical-Systems (MOEMS) that modulate the input light such that ON-light is reflected in a direction different From OFF-light.

FIG. 8 shows a perspective view of a realization of the sixth implementation shown in FIG. 5F. The light source and the time-multiplex system of the spatial light modulating system are omitted. The illumination sequence consists of light with two bands (one short wavelength band and one long wavelength band) at all illumination states. As an example, a sequence of B1R1, B2R2, and G1G2 is fed into the system. These two bands are split by a splitter with short-pass characteristics (SHORT-PASS), such that a sequence of short wavelength bands (B1,B2,G1) transmits the short-pass and illuminates a first spatial modulator (M1), while a sequence of longer wavelength bands (R1,R2,G2) illuminates a second spatial illuminator (M2) through a prism with a total internal reflection surface (TIR₁, TIR₂) each. In this example, the modulators might be MOEMS. The spatially modulated beams (a sequence of R1,R2, and G2 and a sequence of B1, B2 and G1) are reflected by the TIR-surfaces. The short wavelength outputs (SWL) and the long wavelength output (LWL) are added by an adder, which in the example is a long-pass (LONG-PASS).

FIG. 9A schematically shows a perspective view of a first rotatory actuator disclosed with this application. It can be used as a time-multiplexing system (MUX) in the sixth implementation. The figure shows a drum with three curved surfaces of a cylinder, each of which bears filters which transmit or reflect light of two wavelength bands: one band of the short wavelength range (B1, B2, G1) and at the same location one band of the long wavelength range (G2, R1, R2). Exemplarily, the combinations are B1R1, B2B2, G1G2. FIG. 9B schematically shows a side view of a second rotatory actuator usable as a time-multiplexing system (MUX) in the sixth implementation. This figure shows a color wheel with three segments, each of which bears filters which transmit or reflect light of two wavelength bands: one band of the short wavelength range (B1, B2, G1) and one band of the long wavelength range (G2, R1, R2). Exemplarily the combinations are B1G2, B2R1, G1R2; other combinations are possible.

FIG. 10A schematically shows a perspective view of a third rotatory actuator usable as the time-multiplexing system (MUX) in the fourth and seventh implementation. The figure shows a composite color drum comprising two cylinders. Each of the cylinders bears three surfaces. The three surfaces of the first cylinder bear filters, which transmit or reflect one of the short wavelength bands each (B1, B2, G1), and the three surfaces of the second cylinder bear filters, which transmit or reflect one of the long wavelength bands each (G2, R1, R2).

FIG. 10B schematically shows a side view of a fourth rotatory actuator usable as the time-multiplexing system (MUX) in the fourth and seventh implementation. The figure shows a composite color wheel comprising two concentric color wheels. Each of the color wheels bears three segments. The three segments of the first wheel bear filters, which transmit or reflect one of the short wavelength bands each (B1, B2, G1), and the three segments of the second wheel bear filters, which transmit or reflect one of the long wavelength bands each (G2, R1, R2).

FIG. 11A schematically shows a perspective view of two rotatory actuators usable as time-multiplexing systems (MUX) in the fourth and seventh implementation. The figure shows two color drums, each comprising three surfaces. The three surfaces of the first drum bear filters, which transmit or reflect one of the short wavelength bands each (B1, B2, G1), and the three surfaces of the second drum bear filters, which transmit or reflect one of the long wavelength bands each (G2, R1, R2).

FIG. 11B schematically shows a side view of two rotatory actuators usable as time-multiplexing systems (MUX) in the fourth and seventh implementation. The figure shows two color wheels, each comprising three segments. The three segments of the first wheel bear filters, which transmit or reflect one of the short wavelength bands each (B1, B2, G1), and the three segments of the second wheel bear filters, which transmit or reflect one of the long wavelength bands each (G2, R1, R2).

It will be appreciated that whilst this invention is described by way of detailed embodiments, these realizations serve as illustrations of the invention but not as a limitation of the invention; numerous variations in form and detail can now be deduced by those skilled in the art or science to which the invitation pertains without leaving the scope of the invention as defined by the following claims:

1. 6-color multi-channel image engine comprising
a spatial light modulation system (SLMS) configured to output two spatially modulated light beams, a short wavelength beam (SWL) and a long wavelength beam (LWL), whereby
the short wavelength beam (SWL) comprises spatially modulated light with short wavelengths, defined by the range of three different wavelength bands, a first blue (B1), a second blue (B2), and a first green (G1),
the long wavelength beam (LWL) comprises spatially modulated light with long wavelengths, defined by the range of three different wavelength bands, a second green (G2), a first red (R1), and a second red (R2),
light with the first or second blue wavelength bands (B1, B2) is able to excite the blue receptors of the human eye,
light with the first or second green wavelength bands (G1, G2) is able to excite the green receptors of the human eye,
light with the first or second red wavelength bands (R1, R2) is able to excite the red receptors of the human eye,
the central wavelength of the first green wavelength band is shorter than the central wavelength of the second green wavelength band (C_{G1}<C_{G2}),
the spatial light modulating system is configured to spatially modulate each of the 6 wavelength bands (B1,B2,G1,G2,R1,R2) independently,
neither the short wavelength beam (SWL), which comprises blue and green wavelength bands, nor the long wavelength beam (LWL), which comprises green and red wavelength bands, span a human trichromatic RGB color space;
a combiner (ADDER) configured to combine the short and the long wavelength beams (SWL, LWL) into a common output beam (OUT).

2. Engine according to claim 1 whereby the combiner (ADDER) is a color adder.

3. Engine according to claim 2 whereby the color adder (ADDER) works as a short-pass.

4. Engine according to claim 2 whereby the color adder (ADDER) works as a long-pass.

5. Engine according to claim 2 whereby the color adder comprises a long-pass and a short-pass crossing each other (X-ADDER).

6. Engine according to claim 1 whereby the combiner (ADDER) comprises a polarizing beam splitter.

7. Method using an engine according to claim 1 to project a 6-color image.

8. Method using an engine according to claim 1 to project a stereo image.

9. Engine according to claim 1 comprising six light sources and six spatial modulators (FIG. 5A).

10. Engine according to claim 1 comprising six light sources and two spatial modulators (FIG. 5B).

11. Engine according to claim 1 comprising two light sources and six spatial light modulators (FIG. 5C).

12. Engine according to claim 1 comprising two light sources and two spatial light modulators (FIG. 5D).

13. Engine according to claim 1 comprising one light source and six spatial light modulators (FIG. 5E).

14. Engine according to claim 1 comprising one light source and two spatial light modulators (FIGS. 5F,G).

15. Engine according to claim 1 wherein the spatial light modulating system (SLMS) comprises a time-multiplex system (MUX).

16. Engine according to claim 15 comprising a rotatory actuator as a time-multiplex system (MUX).

17. Rotatory actuator for a 6-color image engine (FIG. 9) comprising an arrangement of a first, a second and a third partial surface on a rotatory surface, which is either formed as a ring of a disk configured to rotate around its center or formed as a curved surface area of a cylinder, configured to rotate around its axis, whereby the three partial surfaces are configured to reflect or transmit light with 6 different wavelength bands, a first and a second blue (B1, B2), a first and a second green (G1, G2), and a first and a second red (R1, R2), whereby
the first surface is configured to transmit or reflect the first blue (B1) and a first wavelength band of the long wavelength range defined by the second green and the two reds (G2,R1,R2),
the second surface is configured to transmit or reflect the second blue (B2) and a second wavelength band of the long wavelength range defined by the second green and the two reds (G2,R1,R2),
the third partial surface is configured to transmit or reflect the first green (G1) and a third wavelength band of the long wavelength range defined by the second green and the two reds (G2,R1,R2),
light with the first or second blue wavelength bands (B1,B2) is able to excite the blue receptors of the human eye,
light with the first or second green wavelength bands (G1, G2) is able to excite the green receptors of the human eye,
light with the first or second red wavelength bands (R1, R2) is able to excite the red receptors of the human eye,
the central wavelength of the first green wavelength band (G1) is shorter than the central wavelength of the second green wavelength band (C_{G1}<C_{G2}).

18. Rotatory actuator for a 6-color image engine (FIG. 10) comprising
6 partial surfaces, configured to reflect or transmit light with 6 different wavelength bands, a first and
a second blue (B1, B2), a first and a second green (G1, G2), and a first and a second red (R1, R2), whereby
light with the first or second blue wavelength bands (B1,B2) is able to excite the blue receptors of the human eye,
light with the first or second green wavelength bands (G1, G2) is able to excite the green receptors of the human eye,
light with the first or second red wavelength bands (R1, R2) is able to excite the red receptors of the human eye,
the central wavelength of the first green wavelength band is shorter than the central wavelength of the second green wavelength band (C_{G1}<C_{G2});
a first and a second rotatory surface, which are either formed as rings of a disk configured to rotate around its center or formed as curved surface areas of a cylinder, configured to rotate around its axis, whereby
the first rotatory surface comprises the first, the second and the third partial surface, whereby the first partial surface is configured to transmit or reflect light with the first blue wavelength band (B1), the second partial surface is configured to transmit or reflect light with the second blue wavelength band (B2), and the third partial surface is configured to transmit or reflect light with the first green wavelength band (G1), and
the second rotatory surface comprises the fourth, the fifth and the sixth partial surface, whereby the fourth partial surface is configured to transmit or reflect light with the second green wavelength band (G2), the fifth partial surface is configured to transmit or reflect light with the first red wavelength band (R1), and the sixth partial surface is configured to transmit or reflect light with the second red wavelength band (R2).

19. Rotatory actuator pair for a 6-color image engine (FIG. 11), comprising
6 partial surfaces, configured to reflect or transmit light with 6 different wavelength bands of a first and a second blue (B1, B2), a first and a second green (G1, G2), and a first and a second red (R1, R2), whereby
light with the first or second blue wavelength bands (B1,B2) is able to excite the blue receptors of the human eye,
light with the first or second green wavelength bands (G1, G2) is able to excite the green receptors of the human eye,
light with the first or second red wavelength bands (R1, R2) is able to excite the red receptors of the human eye;
the central wavelength of the first green wavelength band is shorter than the central wavelength of the second green wavelength band (C_{G1}<C_{G2});
a first and a second rotatory actuator, which are either Formed as a ring of a disk configured to rotate around its center or Formed as curved surface areas of a cylinder, configured to rotate around its axis, whereby
the first rotatory actuator comprises the first, the second and the third partial surface, whereby the first partial surface is configured to transmit or reflect light with the first blue wavelength band (B1), the second partial surface is configured to transmit or reflect light with the second blue wavelength band (B2), and the third partial surface is configured to transmit or reflect light with the first green wavelength band (G1), and
the second rotatory actuator comprises the Fourth, the fifth and the sixth partial surface, whereby the Fourth partial surface is configured to transmit or reflect light with the second green wavelength band (G2), the fifth partial surface is configured to transmit or reflect light with the first red wavelength band (R1), and the sixth partial surface is configured to transmit or reflect light with the second red wavelength band (R2).
